(19) United States
(12) Patent Application Publication
(10) Pub. No.: US 2026/0228783 A1
(43) Pub. Date: Aug. 6, 2026

(54) DETECTING, REWRITING, CAPTIONING, AND HYPERLINKING PRODUCT-CAPABLE SUBSTRINGS IN WEB PAGES

(71) Applicant: Paul Valentin Borza, Seattle, WA (US)

(72) Inventor: Paul Valentin Borza, Seattle, WA (US)

(21) Appl. No.: 19/531,171

(22) Filed: Feb. 5, 2026

Related U.S. Application Data
(60) Provisional application No. 63/754,303, filed on Feb. 5, 2025.

(51) Int. Cl. G06Q 30/0241

(52) U.S. Cl. CPC G06Q 30/0277

(57) ABSTRACT

Disclosed are various embodiments for detecting, rewriting, captioning, and hyperlinking product-capable substrings with affiliate links in web pages. Various embodiments of the present disclosure can receive content from a user device. Various embodiments can then identify a product-capable substring based on the content. Based on the product-capable substring, various embodiments can obtain a product information structure that represents a product. In at least some embodiments, the computing environment can send the product information structure to the user device, which can rewrite the web page content in the browser based on the product information structure.

### CROSS-REFERENCE TO RELATED APPLICATION

This application claims the benefit of priority to U.S. Provisional Application No. 63/754,303, filed on February 5, 2025, the entirety of which is incorporated by reference herein.

### BACKGROUND

With the Internet revolution, various physical media businesses (e.g., newspapers, print magazines, etc.) have seen a decline in the demand for printed medium and have since moved their writings to an online environment. Various media platforms (e.g., online newspapers, blogs, podcasts, etc.) have either introduced paywalls and/or advertisements (“ads”) to support paying for their staff and infrastructure.

An alternative way to bring in revenue is through affiliate links, where an article recommends products through trackable links which, if clicked, take the reader to e-commerce retailers (e.g., Amazon.com®, Walmart.com®, Alibaba.com®, eBay.com®, etc.) that run affiliate programs. Affiliate programs enable writers to embed affiliate links into their content and, in return, receive a percentage of the product sale if the product is purchased. However, the embedding of affiliate links can be a tedious task. Typically, embedding affiliate links is manually performed once by an author and never changed subsequently. Various affiliate links may expire (e.g., products are no longer manufactured, products are temporarily out-of-stock, the e-commerce platform changes the link to the product, etc.) leading to revenue loss for writers. Furthermore, not all possible product mentions are hyperlinked with affiliate links, leading to missed income opportunities for content creators and media platforms.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIGS. 2A and 2B show an example flow diagram;

FIG. 3 shows an example diagram;

FIG. 4 shows an example flow diagram; and

FIG. 5 shows an example user interface.

### DETAILED DESCRIPTION

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these cannot be explicitly described, each is specifically contemplated and described herein. This applies to all parts of this application including, but not limited to, steps in described methods. Thus, if there are a variety of additional steps that can be performed it is understood that each of these additional steps can be performed with any specific configuration or combination of configurations of the described methods.

As will be appreciated by one skilled in the art, the methods and systems can take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, the present methods and systems can take the form of web-implemented computer software. Any suitable computer-readable storage medium can be utilized including hard disks, CD-ROMs, optical storage devices, magnetic storage devices, memristors, Non-Volatile Random Access Memory (NVRAM), Random Access Memory (RAM), flash memory, or a combination thereof.

Throughout this application reference is made to block diagrams and flowcharts. It will be understood that each block of the block diagrams and flowcharts, and combinations of blocks in the block diagrams and flowcharts, respectively, can be implemented by processor-executable instructions. These processor-executable instructions can be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions can also be stored in a computer-readable memory that can direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions can also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, can be implemented by special purpose hardware-based computer systems that perform the specified functions or steps, or combinations of special purpose hardware and computer instructions.

This detailed description can refer to a given entity performing some action. It should be understood that this language can in some cases mean that a system (e.g., a computer) owned and/or controlled by the given entity is actually performing the action.

Various embodiments of the present disclosure include one or more automatic ways to modify web pages and insert affiliate links that lead to relevant in-stock products that are closely related to the content mentioned on said web pages. An affiliate link is a link that contains a tracker (typically in the form of a URL parameter) that informs an e-commerce website of the source of the visit. In various embodiments, an affiliate link may use alternative ways rather than a URL parameter, such as a Hypertext Transfer Protocol (HTTP) header (e.g., Referer, a custom HTTP header, etc.) to identify the source of the traffic to the destination website. This way, e-commerce retailers can attribute a sale back to a certain affiliate partner. For example, in the link “https://www.amazon.com/dp/asin/?tag=adlis”, the portion that relates to “?tag=adlis” represents a tracker that Amazon.com® uses to attribute back a sale and issue a certain percentage back to the originating website that embedded the affiliate link.

Websites/web pages can include various content. Content can include text, images, styles, hyperlinks, videos, embedded documents, etc. However, text (including web page content text, hyperlinks, alternate text of images, transcriptions and/or subtitles of embedded audio and video elements, hypertext markup language, etc.) can often be broken into strings or substrings of content. A “string” is one or more characters (e.g., alphanumeric characters, symbols, etc.) placed in a specified order. For example, this paragraph is a string of characters placed in a specified order. A “substring” represents a portion of a string. A substring could be a paragraph, part of a paragraph, a sentence, part of a sentence, etc. A hypertext markup language document can be viewed as one string of characters or as a collection of strings. Each string can be split into two or more substrings, so long as there are enough characters to support such a split.

In at least some embodiments, content can further include text or entities derived from images. Text derived from images can be obtained using optical character recognition, which can convert characters depicted within an image into machine-readable text. The machine-readable text derived from an image can be treated as a string or substring of content in the same manner as text obtained from other sources. In at least some embodiments, content can further include entities identified within images. The entities can include objects, animals, people, scenes, symbols, or other visually recognizable elements depicted in an image. For example, an image can be processed to identify entities such as animals, people, celebrities, sports teams, household items, food items, or other subjects. Identified entities can be represented as strings or substrings and can be processed as product-capable substrings or product recommendation-capable substrings.

Various portions of this disclosure describe strings or substrings as “product-capable.” A product-capable string or substring is a string of characters that could be used to describe some product generically or describe some specific branded product. For example, “SPF 50 sunscreen” may be a product-capable substring from the entire sentence of “When walking on the beach, it’s best to use SPF 50 sunscreen.” “SPF 50 sunscreen” could be representative of a product with generic qualities, but it does not explicitly mention a brand name. Such an example would be a “generic product-capable substring.” By contrast, a sentence like “If you have sensitive skin, Dr. Greene’s Skin Recovery Night Mask is a great option.” where “Dr. Greene’s” is a brand name, contains a “branded product-capable substring” depicted by “Dr. Greene’s Skin Recovery Night Mask.”

Various embodiments of this disclosure also describe “product recommendation-capable substrings.” For example, a sentence like “Stay out of the sun between 10 a.m. and 4 p.m.” neither mentions a branded product nor a generic product. However, such a sentence provides advice and can be complemented with a generic product recommendation. For example, the sentence above can be rewritten, by a Large Language Model or similarly Artificial Intelligence (AI) system, to become “Stay out of the sun between 10 a.m. and 4 p.m., and if you need to be outdoors, make sure to use a broad-spectrum sunscreen with at least SPF 30 for added protection.” The system would then not only rewrite the existing sentences written by humans, but also hyperlink parts of the AI-generated content back to an e-commerce retailer website with affiliate hyperlinks.

Various affiliate links may expire (e.g., products are no longer manufactured, products are temporarily out-of-stock, the e-commerce platform changes the link to the product, etc.) leading to revenue loss for content creators. Additionally, content creators and media platforms may be missing out on opportunities to place affiliate links within their copy to better maximize affiliate click-throughs. Various embodiments address these problems by hyperlinking generic product substrings and/or branded product substrings automatically within the content of the web page. Various embodiments also address these problems by rewriting product recommendation-capable substrings to include one or more generic product substrings and/or branded product substrings, and subsequently hyperlinking the generic product substrings and/or branded product substrings automatically within the content of the web page.

In at least some embodiments, content of a web page can include images that depict people, products, apparel, accessories, scenes, or other visually identifiable elements. Such images can be analyzed to generate textual descriptions that describe what is depicted in the images and that include branded product-capable substrings, generic product-capable substrings, or product recommendation-capable substrings inferred from the visual content. The generated textual descriptions can be based on visual features of the images, surrounding textual content, alternate text attributes, or combinations thereof. The image-derived textual descriptions can be treated as content of the web page and processed for rewriting, ranking, hyperlinking, or presentation in the same manner as text originally authored by a human.

In at least some embodiments, product-capable substrings can be detected, rewritten, and ranked automatically based on content of a web page. After such automatic processing, one or more editorial controls can be applied to influence selection or presentation of products associated with the detected substrings. The editorial controls can be configured to allow, restrict, or prioritize products based on predefined criteria, including product type, brand, availability, or other attributes. The editorial controls can be applied without disabling automatic detection or ranking and can coexist with fully automated embodiments described herein.

In at least some embodiments, the systems and methods described herein improve operation of computing systems that process web content by reducing network requests and reducing redundant computation associated with affiliate link management. The automatic detection, rewriting, ranking, and insertion of product-capable substrings enables a computing system to dynamically transform web page content in a manner that could not be practically performed manually at scale or in real time.

In some embodiments, the disclosed techniques improve efficiency of content processing by automatically identifying relevant portions of content and selectively modifying only those portions, rather than reprocessing entire documents. By operating on substrings derived from structured and unstructured content, including text derived from images, the system reduces computational overhead associated with repeated parsing, rewriting, and hyperlink validation. In at least some embodiments, the disclosed techniques further improve network efficiency and system performance by dynamically maintaining affiliate links that correspond to currently available products, thereby reducing failed requests, stale hyperlinks, and unnecessary redirection events. The automatic replacement of expired or unavailable affiliate links reduces repeated user navigation failures and associated network traffic.

In some embodiments, the disclosed systems improve reliability and consistency of rendered web pages by programmatically coordinating content rewriting, hyperlink insertion, and editorial controls using defined processing stages and thresholds. This coordination enables predictable, repeatable modification of web content that adapts to changes in product availability, content structure, and user-defined constraints without requiring intervention or re-publication of the web page.

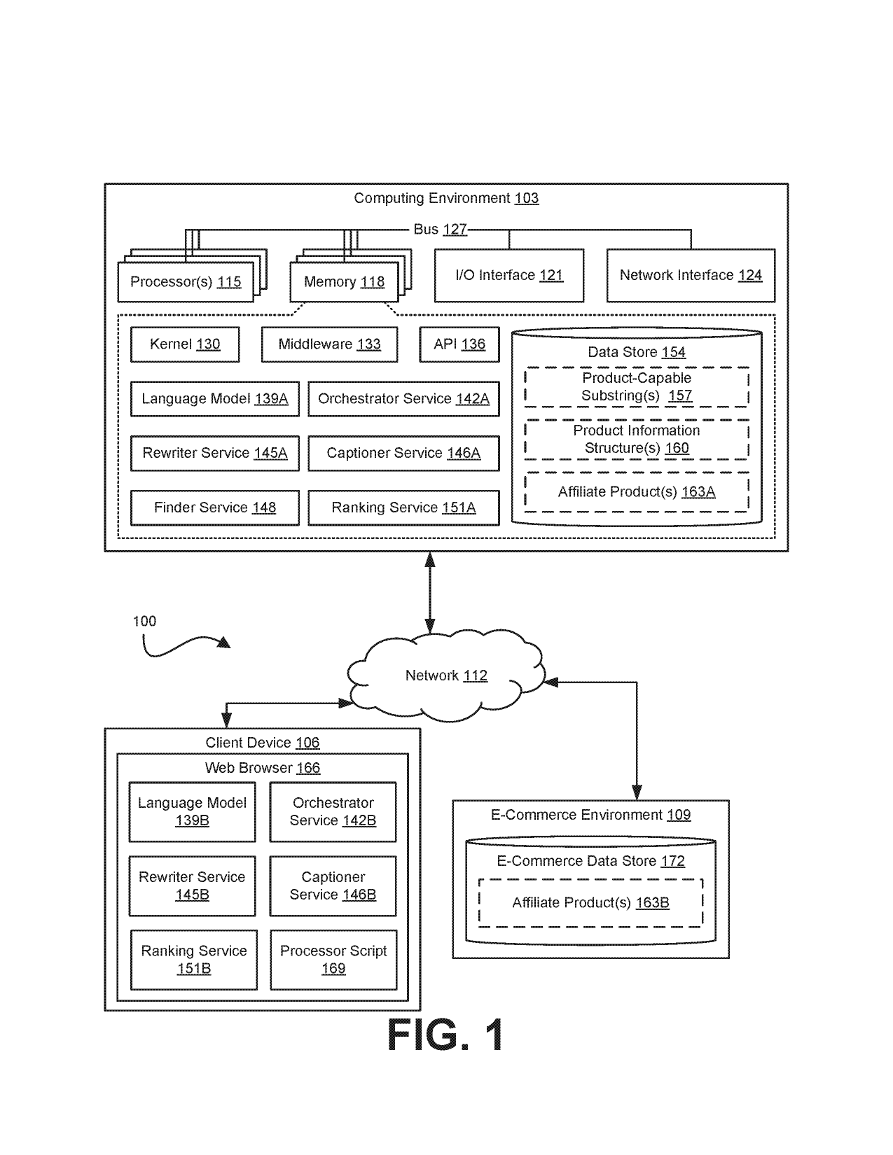

With reference to FIG. 1, shown is a network environment 100 according to various embodiments. The network environment 100 can include a computing environment 103, a client device 106, and an e-commerce environment 109, which can be in data communication with each other via a network 112.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., Wi-Fi^{®}), Bluetooth^{®} networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The computing environment 103 can include one or more computing devices. For example, the computing devices can be configured to perform computations on behalf of other computing devices or applications. As another example, such computing devices can host and/or provide content to other computing devices in response to requests for content. In various embodiments, the computing environment 103 can include a processor 115, a memory 118, an input/output (IO) interface 121, and/or a network interface 124, in data connection with each other over a bus 127 or over the network 112. Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

The bus 127 can include a circuit for connecting the bus 127, the processor 115, the memory 118, the network interface 124, and the input/output interface 121 to each other and for delivering communication (e.g., a control message and/or data) between the bus 127, the processor 115, the memory 118, the network interface 124, and the input/output interface 121.

The processor 115 can include one or more of a Central Processing Unit (CPU), an Application Processor (AP), and a Communication Processor (CP). The processor 115 can control, for example, at least one of the bus 127, the memory 118, the network interface 124, and the input/output interface 121 of the computing environment 103 and/or can execute an arithmetic operation or data processing for communication. The processing (or controlling) operation of the processor 115 according to various embodiments is described in detail with reference to the following drawings.

The processor-executable instructions executed by the processor 115 can be stored and/or maintained by the memory 118. The memory 118 can include a volatile and/or non-volatile memory. The memory 118 can comprise random-access memory (RAM), flash memory, solid state or inertial disks, or any combination thereof. The memory 118 can store, for example, a command or data related to at least one of the bus 127, the processor 115, the network interface 124, and the input/output interface 121 of the computing environment 103. As an example, the memory 118 can store a software and/or a program. The program can include, for example, a kernel 130, a middleware 133, an Application Programming Interface (API) 136, a language model 139A (generically as language model 139), an orchestrator service 142A (generically as orchestrator service 142), a rewriter service 145A (generically as rewriter service 145), a captioner service 146A (generically as captioner service 146), a finder service 148, and/or a ranking service 151A (generically as ranking service 151), or the like, configured for controlling one or more functions of the computing environment 103 and/or an external device. At least one part of the kernel 130, middleware 133, or API 136 can be referred to as an Operating System (OS). The memory 118 can include a computer-readable recording medium having a program recorded therein to perform the method according to various embodiments by the processor 115.

The kernel 130 can control or manage, for example, system resources (e.g., the bus 127, the processor 115, the memory 118, etc.) used to execute an operation or function implemented in other programs (e.g., the middleware 133, the API 136, the language model 139A, the orchestrator service 142A, the rewriter service 145A, the captioner service 146A, the finder service 148, and/or the ranking service 151A). Further, the kernel 130 can provide an interface capable of controlling or managing the system resources by accessing individual constitutional elements of the computing environment 103 in the middleware 133, the API 136, the language model 139A, the orchestrator service 142A, the rewriter service 145A, the captioner service 146A, the finder service 148, and/or the ranking service 151A.

The middleware 133 can perform, for example, a mediation role so that the API 136, the language model 139A, the orchestrator service 142A, the rewriter service 145A, the captioner service 145A, the finder service 148, and/or the ranking service 151A can communicate with the kernel 130 to exchange data. Further, the middleware 133 can handle one or more task requests received from the language model 139A, the orchestrator service 142A, the rewriter service 145A, the captioner service 146A, the finder service 148, and/or the ranking service 151A according to a priority. For example, the middleware 133 can assign a priority of using the system resources (e.g., the bus 127, the processor 115, or the memory 118) of the computing environment 103 to at least one of the language model 139A, the orchestrator service 142A, the rewriter service 145A, the captioner service 146A, the finder service 148, and/or the ranking service 151A. For example, the middleware 133 can process the one or more task requests according to the priority assigned to the at least one of the language model 139A, the orchestrator service 142A, the rewriter service 145A, the captioner service 146A, the finder service 148, and/or the ranking service 151A, and thus can perform scheduling or load balancing on the one or more task requests.

The Application Programming Interface (API) 136 can include at least one interface or function (e.g., instruction), for example, for file control, window control, socket control, audio processing/transcribing, video processing/transcribing, or character control, as an interface capable of controlling a function provided by the language model 139A, the orchestrator service 142A, the rewriter service 145A, the captioner service 146A, the finder service 148, and/or the ranking service 151A in the kernel 130 or the middleware 133.

The language model 139 (e.g., language model 139A or language model 139B) can include logic (e.g., hardware, software, firmware, etc.) that can be implemented to perform various actions. The language model 139 can utilize advanced machine learning algorithms to process and analyze a large corpus of data, enabling language model 139 to predict and generate text based on input sequences. Embodiments of the language model 139 can be a Large Language Model (LLM) or a Natural Language Processing (NLP) model, among other models. The architecture of the language model 139 typically includes multiple layers of artificial neurons, organized in a manner that allows for the hierarchical processing of information. Each layer extracts different levels of linguistic features, from basic syntax to complex semantic relationships. The language model 139 employs techniques such as tokenization, embedding, and attention mechanisms to effectively capture and utilize the nuances of human language.

Language model 139 can be pre-trained by ingesting vast amounts of textual data, which serves as the training corpus. This corpus includes diverse sources such as books, articles, websites, and other written materials. Through a process known as training, language model 139 learns patterns, structures, and contextual relationships within the data. The training (or pre-training) process involves adjusting the parameters of the underlying algorithms to minimize prediction errors, thereby enhancing the ability of the language model 139 to identify and generate coherent and contextually appropriate text. The training process can further include providing a corpus of example texts (inputs) along with expected product-capable substrings 157 (outputs). In various embodiments, the model can also undergo a fine-tuning process for further specialization. Upon completion of the training phase, the language model 139 can be deployed for various applications, including but not limited to natural language processing tasks such as text generation, translation, summarization, and sentiment analysis. In various embodiments, the language model 139 can identify product-capable substrings 157 within a text content.

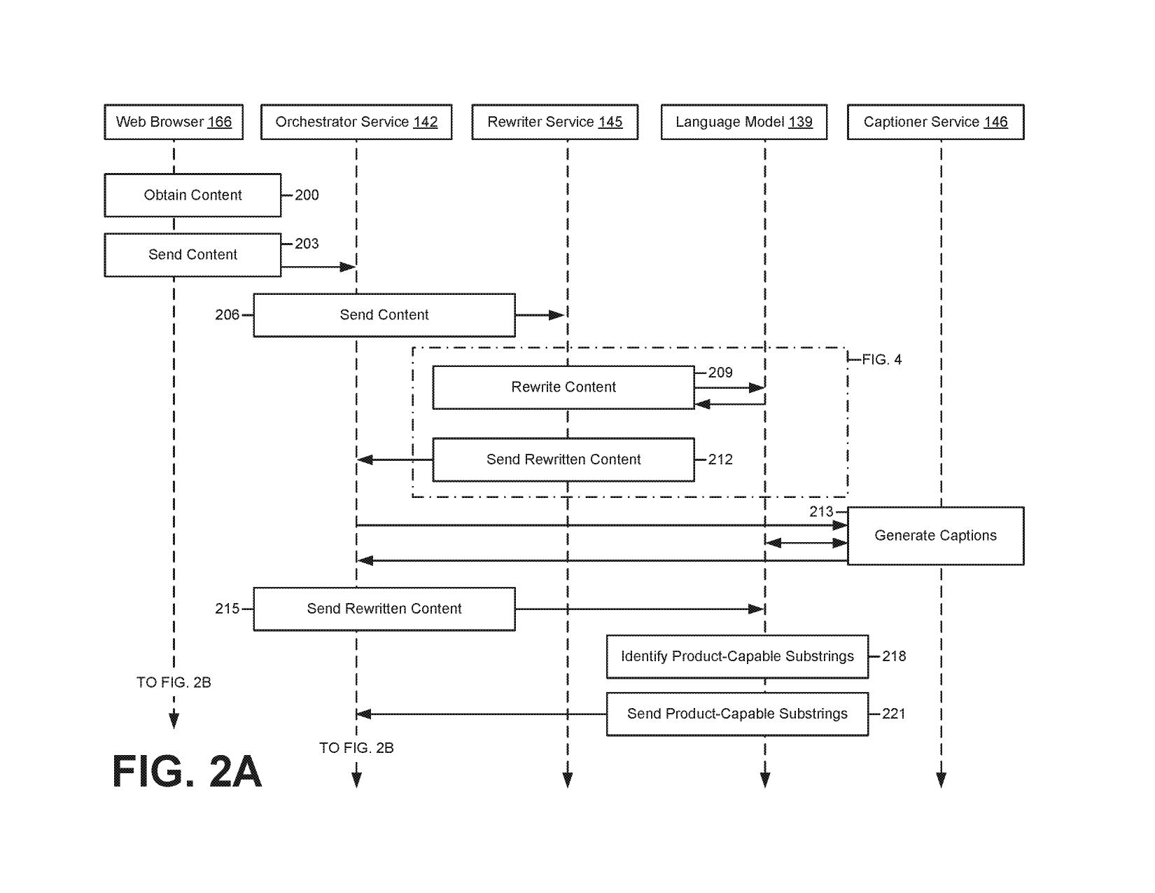

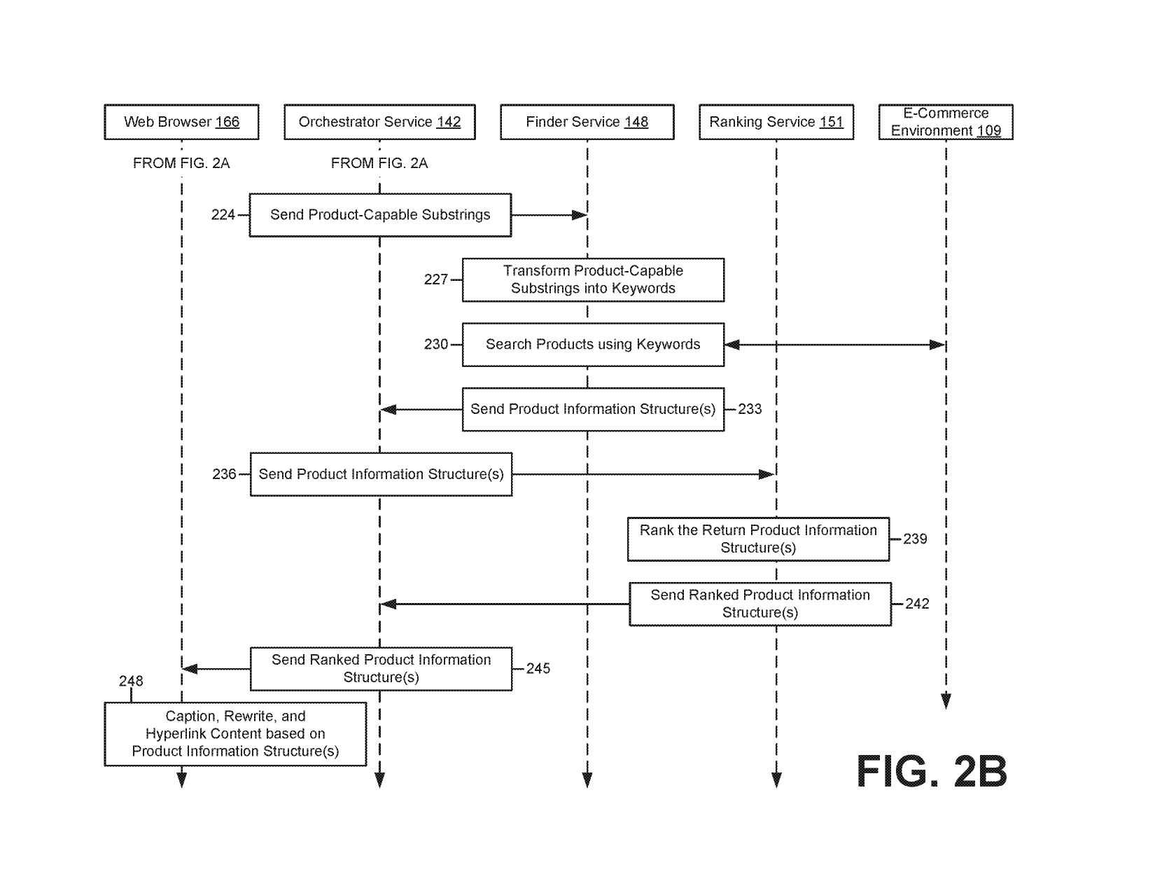

The orchestrator service 142 (e.g., orchestrator service 142A or orchestrator service 142B) can include logic (e.g., hardware, software, firmware, etc.) that can be implemented to perform various actions. In various embodiments, the orchestrator service 142 can communicate with the client device 106, the e-commerce environment 109, the language model 139, the rewriter service 145, the finder service 148, and/or the ranking service 151. In various embodiments, the orchestrator service 142 can perform any or all of the actions described in the sections of the present disclosure associated with the rewriter service 145, the finder service 148, and/or the ranking service 151. In various ways, the orchestrator service 142 is viewed as orchestrating the performance and/or logistics of the actions depicted in FIGS. 2A, 2B, and/or 4.

In various embodiments, the orchestrator service 142 can be a server-side component in a worker/lambda/function running on an edge network, as close to the user as possible to achieve minimal latencies. When the orchestrator service 142 receives a request with the content of the web page and its structure (normally structured as an array, a list, a tuple, a structure, or similar data structure of text-based nodes or as a tree-like structure, such as the Document Object Model (DOM)), the orchestrator service 142 will send the data to the rewriter service 145 to be augmented with generic products related to the meaning of the content in each block of text. The rewriter service 145 may decide to include no other products, one product, or many other products. Then, the orchestrator service 142 can use a language model 139 to detect product-capable substrings 157 in the whole web page. The language model 139 will return the list of product-capable substring 157 candidates that represent both branded product substrings and generic product-capable substrings 157. The orchestrator can send the product-capable substrings 157 to the finder service 148, which can return one or more product information structures 160. The orchestrator service 142 can send the product information structures 160 to the ranking service 151, which can rank the product information structures 160. Subsequently, the orchestrator service 142 can send the ranked product information structures 160 to the client device 106.

The rewriter service 145 (e.g., rewriter service 145A or rewriter service 145B) can include logic (e.g., hardware, software, firmware, etc.) that can be implemented to rewrite or augment portions of content. When the orchestrator service 142 receives a request with the content of the web page and its structure (normally structured as an array, a list, a tuple, a structure, or similar data structure of text-based nodes or as a tree-like structure, such as the Document Object Model (DOM)), the orchestrator service 142 will send the data to the rewriter service 145 to be augmented or rewritten with generic products related to the meaning of the content in each block of text. The rewriter may decide to include no other products, one product, or many other products.

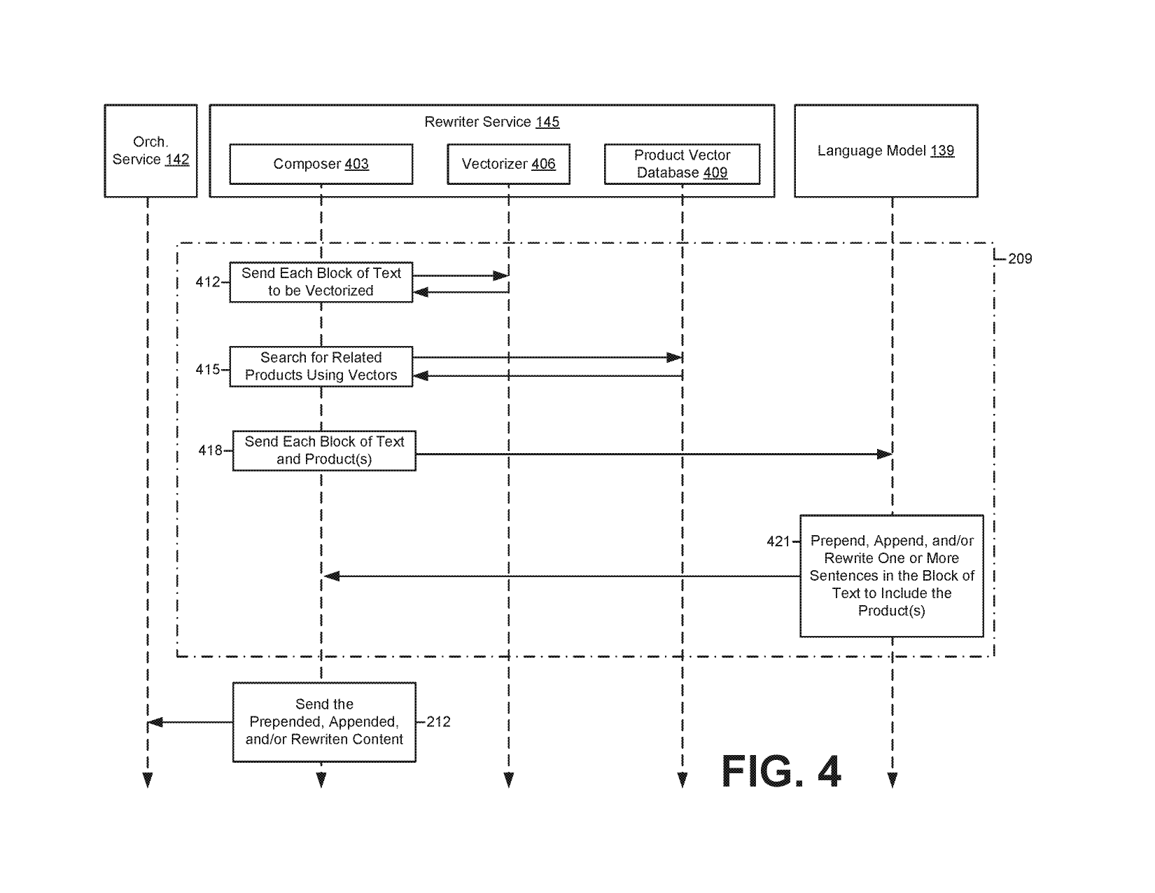

In various embodiments, the rewriter service 145 can include a composer (see FIG. 4, composer 403), which is an inner orchestrator for itself, coordinating the logic inside the rewriter service 145. The composer 403 (FIG. 4) can send each block of text (normally, a paragraph, or any other possible subdivision per HTML structure) to a vectorizer (see FIG. 4, vectorizer 406) for vectorization to then be searched for related matches in a product vector database (see FIG. 4, product vector database 409) of generic and specific or branded products. The product vector database 409 acts as a repository of allowable generic and specific or branded product recommendations. This database can be generated/created ahead of time either by manual curation or by parsing a large corpus of all web pages from a website and generating product recommendations with the help of the language model 139. Content creators and media platforms can supervise the curation to avoid encountering cases where the system recommends bad products, such as perishable, violent, or dangerous products, etc., whichever do not comply with the terms of use of the website on which the system runs. The vector search performed on the product vector database 409 may use a matching minimum threshold or a top count limit to reduce the number of returned results. The results can be then passed to a Language Model, such as language model 139. The decision to either prepend, append, or rewrite certain sentences can either be delegated to the language model 139 or decided based on outcome from A/B testing.

The rewriter service 145 can also be configured to create new paragraphs (additionally or optionally to rewriting existing paragraphs) which can include zero, one, or many branded product-capable substrings 157 or generic product-capable substrings 157, based on the context of nearby existing paragraphs and/or the context of the entire web page. Alternatively, a Language Model (e.g., language model 139) can be replaced with a static template-based set of strings to be prepended, appended, or inserted in the middle of a block of text for simplicity and/or speed. In this case, a sentence splitter algorithm will have to be used to detect start and end positions of sentences. In various embodiments, a Language Model (e.g., language model 139) can be used before the composer (see FIG. 4, composer 403) returns the results to the orchestrator in the form of an “LLM-as-a-judge” to verify that the augmented block of text sounds human-like. A score may be returned by the LLM on which a minimum threshold can be enforced, or an LLM can be used as a binary classifier to signal a pass-fail to guarantee high-quality outputs.

The rewriter service 145 can rewrite the original content from the web page to include generic products block-by-block, or not modify any of the blocks, while keeping the original content as is. In various embodiments, the rewriter service 145 can increase the rate at which the content creator and media platform can insert affiliate links, even when a page with many paragraphs does not explicitly mention branded or generic products.

The captioner service 146 (e.g., captioner service 146A or captioner service 146B) can include logic (e.g., hardware, software, firmware, etc.) that can be implemented to generate textual descriptions for images included within a web page. The generated textual descriptions can include branded product-capable substrings, generic product-capable substrings, or product recommendation-capable substrings derived from visual content depicted in the images. In some embodiments, the captioner service 146 can operate after the rewriter service 145 has completed rewriting or augmenting textual content. By executing after the rewriter service 145, the captioner service 146 can avoid rewriting or reprocessing caption text generated for images, thereby preventing redundant rewriting of image-associated content. The captioner service 146 can generate new text independently of the rewritten textual blocks processed by the rewriter service 145.

In at least some embodiments, the captioner service 146 can process image data associated with a web page. The image data can include one or more of a uniform resource locator (URL) of an image, a base64-encoded representation of the image, image dimensions, or metadata extracted from image tags within the web page. The captioner service 146 can generate a textual description of the image based on visual features detected within the image and, in some embodiments, based on surrounding textual content associated with the image. In some embodiments, the captioner service 146 can utilize a language model, including a multi-modal language model capable of consuming both image data and text data, to generate the textual description. The textual description can reference entities, apparel, accessories, or other products visually depicted in the image. In cases where identification of entities depicted in the image benefits from contextual information, the captioner service 146 can incorporate surrounding text, alternate text, or other nearby content to inform generation of the textual description. In at least some embodiments, the captioner service 146 can output the generated textual description as a block of content associated with a corresponding image. The generated content can be structured to be rendered as a caption element proximate to the image on the web page. The generated content can include product-capable substrings suitable for downstream processing by the finder service 148 and the ranking service 151, in the same manner as product-capable substrings derived from textual content.

The finder service 148 can include logic (e.g., hardware, software, firmware, etc.) that can be implemented to convert each substring into a set of keywords adequate for searching. For example, the finder service 148 can remove stop words (i.e., “the,” “I,” “what,” “if,” etc.); stem the remaining words; and de-duplicate such stemmed words. Such transformations yield better chances to find products that the substring mentions, which is helpful when a search API is not optimized.

The finder service 148 can also send a request to an e-commerce environment 109 to obtain affiliate products 163B. In various embodiments, the request to the e-commerce environment 109 can be a search. Such a search can be based on the keywords extracted from the substring. For each substring and set of keywords tuple, the finder service 148 (or the orchestrator service 142) can make serial or parallel requests to the e-commerce environment 109 to obtain the affiliate products 163B, and then parse the results (and optionally remove ads listings) to extract metadata about each product listing from its search results. Such metadata includes the substring, the title of the product, its brand, its manufacturer, its description, its price, in-stock availability, number of ratings, average rating, etc. Each of these affiliate products 163B, along with their corresponding metadata, can be represented as a product information structure 160. The finder service 148 can return the product information structures 160 (including the affiliate products 163B and their corresponding metadata) to the orchestrator service 142. The finder service 148 can also store the affiliate products 163B in the data store 154 as affiliate products 163A.

The ranking service 151 (e.g., ranking service 151A or ranking service 151B) can include logic (e.g., hardware, software, firmware, etc.) that can be implemented to rank the products to find the most likely product to recommend based on the searched substring candidate from the original sentence. In various embodiments, the ranking service 151 can use the product most recommended by the e-commerce environment 109. In various embodiments, the ranking service 151 can rank the products based on one or more of: a current and past price history; a price sensitivity of customers by performing a reverse lookup of IP address to infer ZIP code, city, county, and country; a user interest by tracking past clicks; an average review stars; a total number of reviews; an in-stock availability of the product; a price discount/sale/bulk offers; a cosine-similarity of embeddings between keywords extracted from the substring, nearby substrings/sentences/paragraphs or whole page, and the product’s listing title or description from the e-commerce retailers; a natural language processing algorithm that can include part of speech tagging to extract most important keywords (for example, nouns and adjectives) and ensure match with information from the product listing; and/or a system that can employ a machine learning model (e.g., Personalized Bayesian Ranking, etc.) to find the most suitable product for a user as long as it fits the generic description mentioned in text. In at least some embodiments, the ranking service 151 can decide there are no good-enough matches. In such a case, the ranking service 151 can discard the substring candidate, even though the language model 139 detected it as a product-capable substring 157 candidate.

The memory 118 can also include a data store 154. The data store 154 can be representative of a plurality of data stores 154, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 154 is associated with the operation of the various applications or functional entities described below. This data can include product-capable substrings 157, product information structures 160, and affiliate products 163A, and potentially other data.

The orchestrator service 142 or the rewriter service 145 can store content generated by the rewriter service 145 into the data store 154. The rewriter service 145 can often perform various processor intensive tasks, such as searching for related content and rewriting or augmenting portions of web content to expand the possible product listings on the page. To not repeat overly processor intensive tasks, the orchestrator service 142 or the rewriter service 145 can store content generated by the rewriter service 145 into the data store 154, which can be obtained by the orchestrator service 142 or the rewriter service 145 subsequently.

The orchestrator service 142 or the language model 139 can store product-capable substrings 157 into the data store 154. A product-capable substring 157 is a string of characters that could be used to describe some product generically or describe some specific branded product. For example, “SPF 50 sunscreen” may be a product-capable substring 157 from the entire sentence of “When walking on the beach, it’s best to use SPF 50 sunscreen.” “SPF 50 sunscreen” could be representative of a product with generic qualities, but it does not explicitly mention a brand name. Such an example would be a “generic product-capable substring.” By contrast, a sentence like “If you have sensitive skin, Dr. Greene’s Skin Recovery Night Mask is a great option.” where “Dr. Greene’s” is a brand name, contains a “branded product-capable substring” depicted by “Dr. Greene’s Skin Recovery Night Mask.”

Various embodiments of this disclosure also describe “product recommendation-capable substrings,” which are another subset of product-capable substrings 157. For example, a sentence like “Stay out of the sun between 10 a.m. and 4 p.m.” neither mentions a branded product nor a generic product. However, such a sentence provides advice and can be complemented with a generic product recommendation. For example, the sentence above can be rewritten, by a Large Language Model or similarly Artificial Intelligence (AI) system, to become “Stay out of the sun between 10 a.m. and 4 p.m., and if you need to be outdoors, make sure to use a broad-spectrum sunscreen with at least SPF 30 for added protection.” Various embodiments of the present disclosure could rewrite the existing sentences and hyperlink parts of the AI-generated content back to an e-commerce retailer website with affiliate hyperlinks.

The orchestrator service 142 or the finder service 148 can store product information structures 160 into the data store 154. The orchestrator service 142 or the finder service 148 can obtain the affiliate products 163B, and then parse the results (and remove ads listings) to extract metadata about each product listing from its search results, thereby generating product information structures 160. The product information structures 160 can include the title of the product, its brand, its manufacturer, its description, its price, in-stock availability, number of ratings, average rating, etc. Each of these affiliate products 163B, along with their corresponding metadata, can be represented as a product information structure 160.

The orchestrator service 142 or the finder service 148 can store affiliate products 163A into the data store 154. Affiliate products 163 are products that are representative of some product-capable substring 157 that is being sold by an e-commerce retailer (by an e-commerce environment 109). The affiliate products 163 can be associated with product metadata such as the title of the product, its brand, its manufacturer, its description, its price, in-stock availability, number of ratings, average rating, etc. The affiliate products 163 can also include a link (e.g., a Uniform Resource Locator (URL)) to locate or navigate to the product listing on an e-commerce website.

In at least some embodiments, the computing environment 103 can cache processing results associated with previously processed content to reduce repeated computation. In some embodiments, cached results can be indexed or retrieved based on a uniform resource locator (URL) of a web page. In at least some embodiments, the computing environment 103 can additionally or alternatively employ semantic caching. In such embodiments, cached results can be indexed or retrieved based on a representation of the content itself rather than, or in addition to, the URL of the web page. The representation of the content can be generated from the text of the web page, including normalized text, token sequences, or feature representations derived from the content.

In some embodiments, the computing environment 103 can generate one or more similarity fingerprints for the content using locality-sensitive hashing techniques. The locality-sensitive hashing techniques can include, for example, MinHash, SimHash, or other similarity-preserving hashing techniques. The similarity fingerprints can be used to determine whether newly received content is substantially similar to previously processed content. In such embodiments, when the similarity fingerprint of newly received content matches or approximately matches a similarity fingerprint associated with cached content, the computing environment 103 can retrieve cached processing results, including detected product-capable substrings 157, rewritten content, ranked product information structures 160, or affiliate products 163, without reprocessing the content. This can occur even when the URL of the newly received content differs from the URL associated with the cached content. The semantic caching can tolerate minor edits to the content, such as formatting changes, reordered paragraphs, or updated metadata, while still identifying the content as substantially similar. The use of semantic caching can reduce backend computational load and improve processing efficiency while preserving functional behavior described herein.

The input/output interface 121 can include an interface for delivering an instruction or data input from a user (e.g., an operator of the computing environment 103) or from a different external device (e.g., client device 106 or other computing devices) to the different elements of the computing environment 103. The input/output interface 121 can further include an interface for outputting one or more user interfaces to the user. For example, the input/output interface 121 can comprise a display, such as a touch screen display, and/or one or more physical input interfaces (e.g., keyboard, mouse, etc.) configured to receive user inputs. Further, the input/output interface 121 can output an instruction or data received from one or more elements of the computing environment 103 to one or more external devices (e.g., client device 106 or other computing devices).

The network interface 124 can establish, for example, communication between the computing environment 103 and one or more external devices (e.g., client device 106 or other computing devices). For example, the network interface 124 can communicate with the one or more external devices (e.g., the client device 106 or other computing devices) by being connected to the network 112 through wireless or wired communication. The network interface 124 can be configured to communicate with the one or more external devices (e.g., the client device 106 or other computing devices) via the network 112 (e.g., Internet, LAN, etc.). In an example, the network interface 124 can be configured to access the network 112 via a wireless communication interface such as a cellular communication protocol. The cellular communication protocol can comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface can be configured to use a near-distance communication. The near-distance communication interface can include for example, at least one of Wireless Fidelity (Wi-Fi®), Bluetooth®, Bluetooth Low Energy (BLE), Near Field Communication (NFC), Global Navigation Satellite System (GNSS), and the like. According to a usage region or a bandwidth or the like, the GNSS can include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” can be used interchangeably in the present document.

The computing environment 103 can include one or more databases. In one example, the one or more databases can comprise one or more relational databases that use Structured Query Language (SQL) for storing and processing data. In another example, the one or more databases can comprise one or more non-relational databases that use non-Structured Query Language (NoSQL) for storing and processing data. In yet another example, the one or more databases support vector-based searches.

The client device 106 is representative of a plurality of client devices that can be coupled to the network 112. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay^{®} players, Digital Video Disc (DVD) players, set-top boxes, and similar devices), a videogame console, or other devices with like capability. The client device 106 can include one or more displays, such as Liquid Crystal Displays (LCDs), gas plasma-based flat panel displays, Organic Light Emitting Diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as a web browser 166, or other applications. The web browser 166 can be executed in a client device 106 to access network content served up by the computing environment 103, or other servers, thereby rendering a user interface on the display. To this end, the web browser 166 can be a file browser, an Internet-connected browser, a dedicated application, or other executable, and the user interface can include a network page, an application screen, or other user mechanism for obtaining user input. The client device 106 can be configured to execute applications beyond the web browser 166, such as email applications, social networking applications, word processors, spreadsheets, or other applications. The web browser 166 can load a processor script 169 that is configured to capture web page content. In at least some embodiments, the web page content can be retrieved on web page load. In at least some embodiments, the content to be analyzed can be retrieved from Hypertext Markup Language (HTML) elements that allow for user input (e.g., <input>, <textarea>, content-editable elements, etc.). In such an embodiment, a user may wish to rewrite and hyperlink parts of their content with affiliate links. The user can provide the content to be analyzed via user input HTML fields. The content can be sent to the computing environment 103. The processor script 169 can receive one or more product information structures 160. The processor script 169 can then display the product information structures 160 to the user to be included in the transformed content. Alternatively or additionally, the processor script 169 can replace product-capable substrings 157 from within the content to be analyzed with replaceable content associated with the product information structures 160.

In at least some embodiments, the web browser 166 executing on the client device 106 can further include one or more locally executed services and models. For example, the web browser 166 can include a language model 139B, an orchestrator service 142B, a rewriter service 145B, a captioner service 146B, and/or a ranking service 151B that are executed on the client device 106. The language model 139B, the orchestrator service 142B, the rewriter service 145B, the captioner service 146B, and the ranking service 151B can be stored in a memory of the client device 106 and executed by one or more processors of the client device 106.

In such embodiments, the language model 139B, the orchestrator service 142B, the rewriter service 145B, the captioner service 146B, and the ranking service 151B can perform the same or substantially similar functionality on the client device 106 as described herein with respect to the language model 139A, the orchestrator service 142A, the rewriter service 145A, the captioner service 146B, and the ranking service 151A executed in the computing environment 103. For example, the language model 139B can identify product-capable substrings 157 or generate rewritten content, the rewriter service 145B can rewrite or augment content, the ranking service 151B can rank product information structures 160, and the orchestrator service 142B can coordinate execution of such operations on the client device 106. In at least some embodiments, execution of the language model 139B, the orchestrator service 142B, the rewriter service 145B, and/or the ranking service 151B on the client device 106 can reduce or eliminate transmission of content to the computing environment 103. In other embodiments, the client device 106 can selectively perform some operations locally using the language model 139B, the orchestrator service 142B, the rewriter service 145B, and/or the ranking service 151B, while delegating other operations to corresponding services executed in the computing environment 103.

In at least some embodiments, the language model 139B executed on the client device 106 can correspond to a locally hosted large language model provided by the web browser 166. Certain web browsers can support execution of a large language model within the browser environment itself, such that inference operations can be performed locally without transmitting content to the computing environment 103. In such embodiments, the processor script 169 can invoke the language model 139B to perform one or more natural language processing operations, including identifying product-capable substrings 157, generating rewritten content, classifying text, or providing contextual signals for ranking. The language model 139B can be accessed through browser-provided interfaces, application programming interfaces, or execution environments supported by the web browser 166.

In at least some embodiments, use of the language model 139B can reduce or eliminate network requests to the computing environment 103 for language model inference. By performing inference locally on the client device 106, backend computational load and associated costs can be reduced. The functional outputs generated by the language model 139B can be equivalent to outputs generated by the language model 139 executed in the computing environment 103. In some embodiments, the client device 106 can dynamically determine whether to invoke the language model 139B or the language model 139 based on browser capability, configuration settings, availability of local resources, performance considerations, or cost considerations. In such embodiments, the language model 139B and the language model 139 can be used interchangeably or cooperatively while preserving the processing flows described herein.

The e-commerce environment 109 can represent an online retailer. The e-commerce environment 109 can include one or more computing devices or servers to perform various functionality. The e-commerce environment 109 can include a plurality of affiliate products 163B, which can be stored in the e-commerce data store 172. In at least some embodiments, the e-commerce environment 109 can be an ad auction system where advertising parties bid to win placements of their own relevant products for the given substring/set of keywords, rather than relying on a search API or scraping methodology to return product results. As an alternative, the e-commerce environment 109 can be a plurality of e-commerce retailers where multiple requests are made in parallel to all to fetch the best product for a substring/set of keywords.

Moving on to FIGS. 2A and 2B, shown are sequence diagrams that provide at least one example of the interactions between the web browser 166, the orchestrator service 142 (either of orchestrator service 142A or orchestrator service 142B), the rewriter service 145 (either of rewriter service 145A or rewriter service 145B) (only shown in FIG. 2A), the captioner service 146 (either of captioner service 146A or captioner service 146B) (only shown in FIG. 2A), the language model 139 (either of language model 139A or language model 139B) (only shown in FIG. 2A), the finder service 148 (only shown in FIG. 2B), the ranking service 151 (either of ranking service 151A or ranking service 151B) (only shown in FIG. 2B), and the e-commerce environment 109 (only shown in FIG. 2B). The sequence diagrams of FIGS. 2A and 2B provide merely examples of the many different types of functional arrangements that can be employed by the web browser 166, the orchestrator service 142 (either of orchestrator service 142A or orchestrator service 142B), the rewriter service 145 (either of rewriter service 145A or rewriter service 145B) (only shown in FIG. 2A), the captioner service 146 (either of captioner service 146A or captioner service 146B) (only shown in FIG. 2A), the language model 139 (either of language model 139A or language model 139B) (only shown in FIG. 2A), the finder service 148 (only shown in FIG. 2B), the ranking service 151 (either of ranking service 151A or ranking service 151B) (only shown in FIG. 2B), and the e-commerce environment 109 (only shown in FIG. 2B). As an alternative, the sequence diagrams of FIGS. 2A and 2B can be viewed as depicting examples of elements of one or more methods implemented within the network environment 100.

Beginning at FIG. 2A at block 200, the web browser 166 on the client device 106 can obtain content. The web browser 166 can load a processor script 169 that is configured to capture web page content. In at least some embodiments, the web page content can be retrieved on web page load. In at least some embodiments, the content to be analyzed can be retrieved from Hypertext Markup Language (HTML) elements that allow for user input (e.g., <input>, <textarea>, content-editable elements, etc.). In such an embodiment, a user may wish to rewrite and hyperlink parts of their content with affiliate links. The user can provide the content via user input HTML fields. The content can be sent to the computing environment 103. In some embodiments, the content can be maintained on the client device 106. The processor script 169 can receive one or more product information structures 160. The processor script 169 can then display the product information structures 160 to the user to be included in the transformed content. Alternatively or additionally, the processor script 169 can replace product-capable substrings 157 from within the content to be analyzed with replaceable content associated with the product information structures 160.

In some embodiments, website administrators can add the processor script 169 inside the <head></head> portions of every page on which they wish to run the JavaScript. Alternatively, administrators can add the script before the closing tag of </body> without having to include the defer attribute on the script tag. Once the processor script 169 is loaded, the processor script 169 can detect product-capable substrings 157 upon page load. In at least some embodiments, the processor script 169 can be loaded by the web browser 166 using deferred execution. In such embodiments, the processor script 169 can be configured to load without blocking parsing of the web page and to execute after the document has been parsed. In some embodiments, the processor script 169 can be loaded using asynchronous execution. In such embodiments, the processor script 169 can be configured to load asynchronously with respect to parsing of the web page and to execute independently of document parsing order. The asynchronous loading can be specified using an asynchronous loading attribute or an equivalent mechanism supported by the web browser 166. In at least some embodiments, the processor script 169 can be selectively loaded using deferred execution or asynchronous execution based on performance considerations, page structure, content type, or configuration settings.

At block 200, if the page contains client-side rendered content, then a MutationObserver can be used to track changes of the document. This will allow the processor script 169 to run on “below the fold” content that the user has not seen, and which is normally deferred from the initial render on performance-optimized websites. When the processor script 169 detects page mutations and text changes (or a page load), the processor script 169 sends either only the net new content or the full text of the web page for inference yet again. The processor script 169 will also send the structure of the page as separated into blocks of text (normally, paragraphs, or any other possible subdivisions per HTML structure), or a tree-like structure resembling a Document Object Model (DOM). Content creators may be able to exclude portions of a page from being sent via certain HTML attributes (e.g., data-ignore) applied on the HTML elements of interest, causing the processor script 169 to skip these nodes and all their descendants.

In at least some embodiments, execution of the processor script 169 on a given web page can be conditioned on one or more permission rules. The permission rules can define whether content associated with a particular web page, web page path, uniform resource locator (URL), or portion thereof is eligible for processing by the computing environment 103. The permission rules can be configured by a user through a backend interface associated with the computing environment 103.

In some embodiments, the processor script 169 can execute on all web pages of a website, while selectively enabling or disabling content transmission and processing based on the permission rules. For example, the processor script 169 can determine, prior to sending content to the orchestrator service 142, whether a current web page path is allowed or blocked according to the permission rules. If the current web page path is blocked, the processor script 169 can refrain from sending content, metadata, or structural information associated with the web page to the computing environment 103. In some embodiments, the permission rules can include allowlists, blocklists, or combinations thereof. The permission rules can be evaluated locally by the processor script 169, remotely by the orchestrator service 142, or cooperatively by both. In at least some embodiments, the permission rules can be retrieved from the computing environment 103 during initialization of the processor script 169 and cached on the client device 106 for subsequent evaluations. The permission-based control of content processing can be used, for example, during onboarding of new users or websites, to limit automated detection, rewriting, captioning, or hyperlinking to a subset of web pages while allowing the processor script 169 to remain deployed across the website.

Next, at block 203, the web browser 166 on the client device 106 can send the content to the orchestrator service 142. The web browser 166, via the processor script 169, will send the entire contents of the page or sub-contents of the page (e.g. paragraphs of text) to the orchestrator 142. The web browser 166 can also send the structure of the web page by means of arrays, lists, tuples, or similar data structures of blocks of text (normally, paragraphs, or any other possible subdivisions per HTML structure), or a tree-like structure resembling a Document Object Model (DOM). The web browser 166 and orchestrator service 142 can communicate via HTTP or sockets, via text or binary formats, or through various other means.

In at least some embodiments, the computing environment 103 or the client device 106 can include synchronization logic to prevent duplicate processing of the same web page. The synchronization logic can ensure that a given web page is processed only once during a defined processing window. In some embodiments, the synchronization logic can be implemented using one or more mutually exclusive execution mechanisms that are globally coordinated across a plurality of geographic regions. For example, the computing environment 103 can employ one or more durable stateful objects configured to enforce mutual exclusion for processing requests associated with a particular web page identifier, uniform resource locator (URL), or web page path. In such embodiments, when the orchestrator service 142 receives a request to process content associated with a web page, the orchestrator service 142 can attempt to acquire a lock associated with the web page. If the lock is successfully acquired, the orchestrator service 142 can proceed with processing the web page using the rewriter service 145, the language model 139, the finder service 148, and the ranking service 151. If the lock is already held, indicating that the web page is currently being processed or has already been processed, the orchestrator service 142 can refrain from reprocessing the web page. In at least some embodiments, the mutual exclusion mechanism can be synchronized across all regions in which the computing environment 103 operates, such that concurrent requests originating from different geographic locations are coordinated to prevent duplicate processing. The lock can be released upon completion of processing, expiration of a timeout period, or storage of a processing result in the data store 154.

Next, at block 206, the orchestrator service 142 can send the content to the rewriter service 145. Next, at block 209, the rewriter service 145 can rewrite the content. When the orchestrator service 142 receives a request with the content of the web page and its structure, the orchestrator service 142 will send it to the rewriter service 145 to be augmented or rewritten with generic and specific or branded products related to the meaning of the text in each block of text. The rewriter service 145 may decide to include mentions of no other products, one product, or many other products.

In various embodiments, the rewriter service 145 can include a composer (see FIG. 4, composer 403), which is an inner orchestrator for the rewriter service 145, coordinating the logic within the rewriter service 145. The composer 403 (FIG. 4) can send each block of text (normally, a paragraph, or any possible subdivision per HTML structure) to a vectorizer (see FIG. 4, vectorizer 406) for vectorization to then be searched for related matches in a product vector database (see FIG. 4, product vector database 409) of generic and specific or branded products. The product vector database 409 acts as a repository of allowable generic and specific or branded product recommendations. This database can be generated/created ahead of time either by manual curation or by parsing a large corpus of all web pages from a website and generating generic and specific or branded product recommendations with the help of the language model 139. Content creators and media platforms can supervise the curation to avoid encountering cases where the system recommends bad products such as perishable, violent, or dangerous products, etc. whichever do not comply with the terms of use of the website on which the system runs. The vector search performed on the product vector database 409 may use a matching minimum threshold or a top count limit to reduce the number of returned results. The results can then be passed to a Language Model, such as language model 139. The decision to either prepend, append, or rewrite certain sentences can either be delegated to the language model 139 or decided based on outcome from A/B testing. For more information on such an embodiment, see the description of FIG. 4.

The rewriter service 145 can also be configured to create new paragraphs (additionally or optionally to rewrite existing paragraphs) which can include zero, one, or many branded product-capable substrings or generic product-capable substrings, based on the context of nearby existing paragraphs and/or the context of the entire web page. Alternatively, a Language Model (e.g., language model 139) can be replaced with a static template-based set of strings to be prepended, appended, or inserted in the middle of a block of text for simplicity and/or speed. In this case, a sentence splitter algorithm will have to be used to detect start and end positions of sentences. In various embodiments, a Language Model (e.g., language model 139) can be used before the composer (see FIG. 4, composer 403) returns the results to the orchestrator in the form of an “LLM-as-a-judge” to verify that the augmented block of text sounds human-like. A score may be returned by the Language Model (e.g., language model 139) on which a threshold (e.g., a minimum threshold) can be enforced, or an LLM can be used as a binary classifier to signal a pass-fail to guarantee high-quality outputs.

In at least some embodiments, the Language Model referenced above can be a locally executed language model residing on the client device 106. In such embodiments, the Language Model can correspond to the language model 139B executed within the web browser 166 or another execution environment on the client device 106. The language model 139B can perform the same evaluation, scoring, or classification operations as the language model 139 executed in the computing environment 103. In such embodiments, the rewriter service 145 or a local instance of the rewriter service 145B can invoke the language model 139B to evaluate rewritten or augmented content, including generating a score, enforcing a threshold, and/or producing a binary pass-fail signal. The evaluation performed by the language model 139B can be used to determine whether rewritten content is accepted, modified, and/or discarded, without transmitting the content to the computing environment 103.

The rewriter service 145 can rewrite the original text from the web page to include generic products block-by-block, or not modify any of the blocks, while keeping the original text as is. In various embodiments, the rewriter service 145 can increase the rate at which the content creator and media platform can insert affiliate links, even when a page with many paragraphs does not explicitly mention branded or generic products. Next, at block 212, the rewriter service 145 can send the rewritten content to the orchestrator service 142.

Next, at block 213, the orchestrator service 142 can direct the captioner service 146 to process image content associated with the web page. In at least some embodiments, the captioner service 146 can receive, from the orchestrator service 142, image-related data extracted by the processor script 169. The image-related data can include one or more image identifiers, image dimensions, image uniform resource locators (URLs), base64-encoded image data, alternate text attributes, and positional or structural information indicating where each image appears within the web page content.

In some embodiments, the processor script 169 can identify images by parsing image elements within the document object model, including <img> elements, and can extract attributes such as src, srcset, width, and height. When multiple image representations are available, the processor script 169 can select an image representation that satisfies a minimum size threshold to reduce processing of images unlikely to depict relevant physical products. In some embodiments, an image identifier can be generated for each image. The image identifier can comprise a hash value derived from an image URL, from binary image content, or from a combination thereof, such that identical images appearing multiple times on a page or across pages can be identified consistently.

In at least some embodiments, the captioner service 146 can retrieve image data for processing by consuming base64-encoded image data directly or by fetching image content from a URL. The captioner service 146 can store retrieved image data in a data store, such as a key-value store, using the image identifier as a key. In such embodiments, caching of image data can reduce repeated retrieval or decoding of identical images across multiple processing requests.

In some embodiments, the captioner service 146 can analyze each image using a language model, including a multi-modal language model capable of consuming both image data and textual input. The captioner service 146 can provide the language model with the image data together with contextual text associated with the image. The contextual text can include alternate text attributes, surrounding text within a predefined proximity to the image, nearby paragraphs, headings, or other textual content associated with the image location within the web page.

In at least some embodiments, the captioner service 146 can use the contextual text to supplement image understanding when generating textual descriptions. For example, when an image depicts a person and surrounding text references a named individual, the captioner service 146 can provide such contextual text to the language model to improve interpretation of the image and generation of relevant product mentions. The captioner service 146 can generate a textual description that describes visual elements depicted in the image and that includes branded product-capable substrings, generic product-capable substrings, and/or product recommendation-capable substrings inferred from the image content and its context.

In some embodiments, the captioner service 146 can generate caption content to be rendered proximate to the corresponding image on the web page. The caption content can be structured as a block of text suitable for inclusion as a caption element associated with the image. In some embodiments, the captioner service 146 can indicate that an image should be wrapped within a <figure> element and that the generated caption content should be rendered within a <figcaption> element associated with the figure. When an image already includes an existing caption, the captioner service 146 can rewrite or augment the existing caption to include detected branded or generic product-capable substrings.

In at least some embodiments, the captioner service 146 can generate output that associates generated caption text with the corresponding image identifier. The association enables the processor script 169 to correctly insert, update, or rewrite caption content at the appropriate location within the Document Object Model (DOM) when rendering results on the client device 106. The generated caption content can be returned to the orchestrator service 142 for downstream processing in the same manner as other content generated by the rewriter service 145.

In such embodiments, product-capable substrings identified within caption content generated by the captioner service 146 can be forwarded to the finder service 148 and the ranking service 151 for product lookup, ranking, and selection. The caption-derived product-capable substrings can be processed together with product-capable substrings derived from textual content of the web page, while remaining logically associated with the corresponding image.

Next, at block 215, the orchestrator service 142 can send the rewritten content to the language model 139. Next, at block 218, the language model 139 can identify product-capable substrings 157. The language model 139 can detect product entities in the entirety of the web page. The model can return the list of substring candidates that represent both branded product-capable substrings 157 and generic product-capable substrings 157. In some embodiments, the product-capable substrings 157 can be output in JavaScript Object Notation (JSON) format. In some embodiments, the product-capable substrings 157 can be output as offsets and/or intervals referencing the original content.

In at least some embodiments, detected product-capable substrings 157 generated by the language model 139 can be post-processed using fuzzy matching logic prior to downstream processing. The fuzzy matching logic can be configured to determine whether a detected product-capable substring 157 sufficiently corresponds to text present in the original content, even when the detected substring does not exactly match the original text.

In some embodiments, the fuzzy matching logic can evaluate a similarity metric between the detected product-capable substring 157 and one or more candidate substrings extracted from the original content. The similarity metric can be based on an edit distance, character-level difference count, token-level difference count, phonetic similarity, normalization of diacritics or accents, or combinations thereof. A detected product-capable substring 157 can be considered a match when the similarity metric satisfies a pre-defined threshold. For example, when the original content includes a substring of “SPF 50 sunscreen,” and the language model 139 outputs a detected product-capable substring of “SPF 30 sunscreen,” the fuzzy matching logic can determine that the detected substring sufficiently corresponds to the original content based on the similarity metric. In such embodiments, the detected product-capable substring 157 can be aligned with the corresponding substring in the original content for purposes of linking, rewriting, or ranking.

In at least some embodiments, the fuzzy matching logic can improve handling of accented characters, diacritics, or locale-specific spellings by normalizing or partially matching character variations prior to comparison. The fuzzy matching logic can increase detection coverage by tolerating minor discrepancies introduced by the language model 139 while preserving alignment with the original content. In some embodiments, the fuzzy matching logic can be applied by the orchestrator service 142, the language model 139, the finder service 148, or a combination thereof, prior to generation of product information structures 160. Next, at block 221, the language model 139 on the can send the product-capable substrings 157 to the orchestrator service 142.

Continuing to FIG. 2B at block 224, the orchestrator service 142 can send the product-capable substrings 157 to the finder service 148. Next, at block 227, the finder service 148 can transform product-capable substrings 157 into keywords.

Next, at block 230, the finder service 148 can search the e-commerce environment 109 for affiliate products 163B based on the keywords. The finder service 148 can include logic (e.g., hardware, software, firmware, etc.) that can be implemented to convert each substring into a set of keywords adequate for searching. For example, the finder service 148 can remove stop words (e.g., “the,” “I,” “what,” “if,” etc.); stem the remaining words; and de-duplicate such stemmed words. Such transformations yield better chances to find products that the substring mentions, which is helpful when a search API is not optimized.

The finder service 148 can also send a request to an e-commerce environment 109 to obtain affiliate products 163B. In various embodiments, the request to the e-commerce environment 109 can be a search. Such a search can be based on the keywords extracted from the substring. In other embodiments, the request to the e-commerce environment 109 can be a scrape request to fetch the HTML of the search results page rather than an API call. For each substring and set of keywords tuple, the finder service 148 (or the orchestrator service 142) can make serial or parallel requests to the e-commerce environment 109 to obtain the affiliate products 163B, and then parse the results (and optionally remove ads listings) to extract metadata about each product listing from its search results. Such metadata includes the substring, the title of the product, its brand, its manufacturer, its description, its price, in-stock availability, number of ratings, average rating, etc. Each of these affiliate products 163B, along with their corresponding metadata, can be represented as a product information structure 160. The finder service 148 can return the product information structures 160 (including the affiliate products 163B and their corresponding metadata) to the orchestrator service 142. The finder service 148 can also store the affiliate products 163B in the data store 154 as affiliate products 163A. Next, at block 233, the finder service 148 can send the product information structures 160 to the orchestrator service 142.

Next, at block 236, the orchestrator service 142 can send the product information structures 160 to the ranking service 151. Next, at block 239, the ranking service 151 can rank the product information structures 160. In at least some embodiments, the ranking service 151 can evaluate product information structures 160 based on contextual information associated with a detected product-capable substring 157. The contextual information can include text surrounding the location at which the product-capable substring 157 appears within the content. In some embodiments, the contextual information can comprise a portion of the content preceding the product-capable substring 157, a portion of the content following the product-capable substring 157, or a combination thereof. For example, the contextual information can include a predefined number of characters, tokens, or words before and after the detected product-capable substring 157. In one non-limiting example, the contextual information can include approximately two hundred characters preceding the detected product-capable substring 157 and approximately two hundred characters following the detected product-capable substring 157.

In such embodiments, the ranking service 151 can provide the detected product-capable substring 157 together with the associated contextual information as input to a language model, similarity algorithm, or ranking algorithm. The contextual information can be used to disambiguate the intended meaning or usage of the product-capable substring 157 and to improve selection of an appropriate product. For example, when the detected product-capable substring 157 is “tomatoes,” and the surrounding contextual information indicates a cooking recipe, the ranking service 151 can preferentially rank products corresponding to consumable tomatoes rather than products corresponding to seeds or planting supplies. In at least some embodiments, the contextual information can be used to compute relevance scores, embedding similarities, or classification outputs that account for the semantic role of the product-capable substring 157 within the content. The use of contextual information can reduce incorrect product associations and improve alignment between the content and the ranked product information structures 160.

Next, at block 242, the ranking service 151 can send the ranked product information structures 160 to the orchestrator service 142. The ranking service 151 can include logic (e.g., hardware, software, firmware, etc.) that can be implemented to rank the products to find the most likely product to recommend based on the searched substring candidate from the original sentence. In various embodiments, the ranking service 151 can use the product most recommended by the e-commerce environment 109. In various embodiments, the ranking service 151 can rank the products based on one or more of: a current and past price history; a price sensitivity of customers by performing a reverse-lookup of IP address to infer ZIP code, city, county, and country; a user interest by tracking past clicks; an average review stars; a total number of reviews; an in-stock availability of the product; a price discount/sale/bulk offers; a cosine-similarity of embeddings between keywords extracted from the substring, nearby substrings/sentences/paragraphs or whole page, and the product’s listing title or description from the e-commerce retailers; a natural language processing algorithm that can include part of speech tagging to extract most important keywords (for example, nouns and adjectives) and ensure match with information from the product listing; and/or a system that can employ a machine learning model (e.g., Personalized Bayesian Ranking, etc.) to find the most suitable product for a user as long as it fits the generic description mentioned in text. In at least some embodiments, the ranking service 151 can decide there are no good-enough matches. In such a case, the ranking service 151 can discard the substring candidate, even though the language model 139 detected it as a product-capable substring candidate.

Next, at block 245, the orchestrator service 142 can send the ranked product information structures 160 to the web browser 166 on the client device 106. In some embodiments, the orchestrator service 142 can send the ranked product information structures 160 to the web browser 166 as a single response after processing all detected product-capable substrings 157 within the content. In such embodiments, the ranked product information structures 160 can be encoded in a human-readable or non-human readable data format, such a JavaScript Object Notation (JSON) structure, and transmitted using an appropriate content type, such as the “application/json” content type. The web browser 166 can receive the complete set of ranked product information structures 160 prior to performing any modification of the content on the user interface.

In at least some embodiments, the orchestrator service 142 can transmit the ranked product information structures 160 incrementally to the web browser 166 using a streaming response. In such embodiments, each ranked product information structure 160 can be sent to the web browser 166 as soon as processing for a corresponding product-capable substring 157 is completed, without waiting for processing of other product-capable substrings 157 to complete. The streaming response can be encoded using a line-delimited data format, wherein each transmitted data object represents one or more product information structure 160. In the streaming embodiment, each transmitted product information structure 160 can include an indicator identifying whether the structure corresponds to a product mention, to rewritten content, or captioned image. The web browser 166 can receive and process each transmitted product information structure 160 independently and in the order received. The orchestrator service 142 can operate the language model 139, the captioner service 146, the rewriter service 145, the finder service 148, and the ranking service 151 in parallel to enable incremental generation and transmission of product information structures 160. A maximum number of concurrent processing jobs can be enforced by the orchestrator service 142, with additional processing requests queued until computing resources become available.

Next, at block 248, the web browser 166 on the client device 106 can rewrite the content on the user interface based on the product information structures 160. The processor script 169 may decide to rewrite the original substring with the replacement substring or it may decide to link the original substring as is to the product page using an affiliate tracking parameter. In at least one embodiment, the product information structures 160 can indicate that a portion of the content should be rewritten to include newly written content. In some embodiments, parts of the original content or the newly generated content can be hyperlinked based on the product information structures 160. The rewritten and/or hyperlinked content can then be displayed or re-rendered on the client device 106.

In at least some embodiments, the web browser 166 on the client device 106 can present extracted product-capable substrings 157 in a visual interface element separate from inline hyperlinks. In such embodiments, the extracted product-capable substrings 157 can be displayed within a graphical container, such as a carousel, panel, or other visual component rendered within the web page. In some embodiments, a carousel can include one or more visual representations associated with the extracted product-capable substrings 157. The visual representations can include product images, titles, descriptions, pricing information, ratings, or combinations thereof derived from corresponding product information structures 160. The carousel can be positioned at a predefined location within the web page, dynamically inserted into the Document Object Model (DOM), or rendered in proximity to content from which the product-capable substrings 157 were extracted. In such embodiments, the presentation of the extracted product-capable substrings 157 within the carousel does not require modification or hyperlinking of the original text content. Instead, the carousel can provide an alternative user interaction mechanism that enables users to browse or select product recommendations in a visual format. Selection of an item within the carousel can navigate the user to a corresponding product page, affiliate link, or additional information view.

In at least some embodiments, the decision to present product recommendations as inline hyperlinks, as rewritten content, as a carousel, or as a combination thereof can be controlled by configuration settings, page-level rules, or user preferences. The carousel-based presentation can be used to increase visibility of extracted product-capable substrings 157 and to provide a visually distinct user experience without altering the underlying textual content.

In at least some embodiments, the computing environment 103 can provide editorial control over product information structures 160 generated through automatic detection, rewriting, and ranking. The editorial control can enable a user to influence which products, product categories, brands, or product attributes are eligible for presentation after automatic processing has occurred. In some embodiments, the editorial control can be exercised through a backend interface associated with the computing environment 103. The backend interface can allow a user to define editorial rules, preferences, or constraints that govern selection, inclusion, exclusion, or prioritization of product information structures 160. The editorial rules can be applied after the ranking service 151 produces ranked results and before the results are sent to the client device 106. In at least some embodiments, the editorial rules can specify allowable product types, disallowed product types, preferred brands, excluded brands, price ranges, availability requirements, content categories, or combinations thereof. The orchestrator service 142 can apply the editorial rules to filter, reorder, or modify the ranked product information structures 160 prior to delivery. In such embodiments, automatic detection, rewriting, and ranking can remain fully automated, while final selection of products presented to users is subject to editorial oversight. The editorial control can be used to align automatically generated outputs with editorial standards, brand guidelines, regulatory requirements, or user preferences. Once block 248 has completed, the flow diagram of FIGS. 2A and 2B can come to an end.

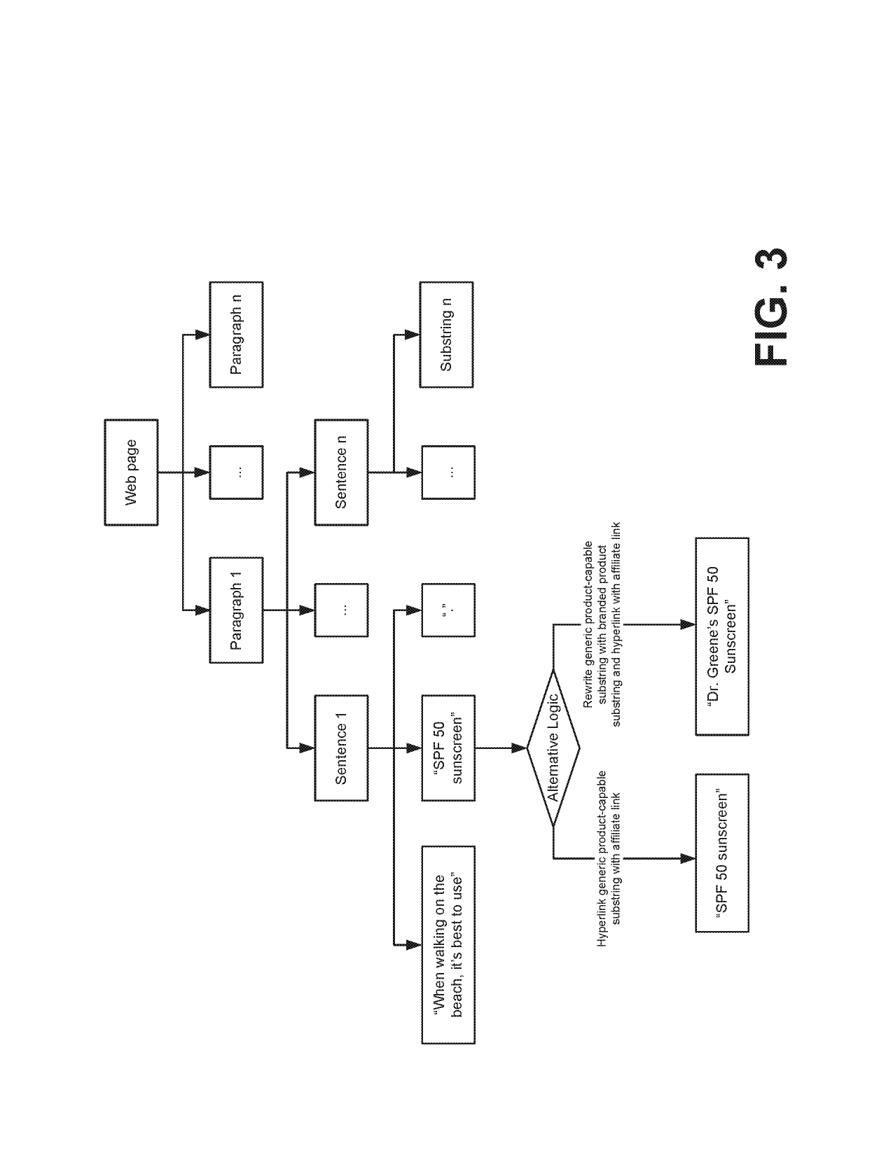

Moving on to FIG. 3, depicted is a diagram showing web page content being broken into sub-parts (e.g., sub-strings). For example, a web page can be broken into paragraphs, such as paragraph 1 through paragraph n. Each paragraph can be broken down into sentences, such as sentence 1 through sentence n. Each sentence can be broken down into substrings, such as “When walking on the beach, it’s best to use,” “SPF 50 sunscreen,” “.,” through substring n. In such examples, “SPF 50 sunscreen” is identified as a product-capable substring 157. Additionally, the diagram of FIG. 3 demonstrates alternative logic for deciding whether a generic product-capable substring 157 is kept as is or rewritten into a branded product-capable substring 157, before it’s hyperlinked to an e-commerce retailer. For example, “SPF 50 sunscreen” would be a generic product-capable substring 157, whereas “Dr. Greene’s SPF 50 Sunscreen” would be a branded product-capable substring 157. The generic product-capable substring 157 in such an example would be able to use any affiliate product 163 that is described by “SPF 50 sunscreen.” However, the branded product-capable substrings 157, such as “Dr. Greene’s SPF 50 Sunscreen,” can only be linked to SPF 50 sunscreen that is made by the manufacturer “Dr. Greene’s.”

Moving on to FIG. 4, depicted is a flow diagram for the rewriter service 145, the orchestrator service 142, and the language model 139. The rewriter service 145 can include a composer 403, a vectorizer 406, and a product vector database 409 that includes products. The depiction of FIG. 4 represents a possible embodiment of blocks 209 and 212, as previously described in FIG. 2A.

Starting at block 412, the composer 403 can send each block of text to be vectorized by a vectorizer 406. Each block of text could comprise paragraphs, sentences, and/or sentence parts. For example, as shown in FIG. 3, a web page can be depicted as various parts, including paragraphs, sentences, and sentence parts. The vectorizer 406 can transform each block of text into vector values using vector embeddings. In at least some embodiments, the vectorizer 406 can be a machine-learning model that can parse text and convert the text into one or more vector values. Subsequently, the vectorizer 406 can return the vector values to the composer 403.

At block 415, the composer 403 can search for related products using the product vector database 409. In various embodiments, the composer 403 can search using the vector values from block 412. The product vector database 409 can return products relevant to the block of text to the composer 403 based on the vector values from block 412. In various embodiments, the product vector database 409 can limit the results to fixed number of products to be returned to the composer 403.

At block 418, the composer 403 can send each block of text (which had previously been sent to the vectorizer 406) along with one or more products to be rewritten, prepended, appended, or otherwise merged by a language model 139. At block 421, the language model 139 can prepend, append, and/or rewrite one or more sentences in the block of text to include the product as a product-capable substring 157, where the resulting generated text is sent back to the composer 403. For example, the composer 403 could send a block of text like: “Walking outside can help boost vitamin D levels.” along with a product like “Dr. Greene’s SPF 50 Sunscreen.” The language model 139 can be trained to take the block of text and product to make a cohesive sentence. For instance, “Walking outside can help boost vitamin D levels, but be sure to apply Dr. Greene’s SPF 50 Sunscreen!” or “When you apply Dr. Greene’s SPF 50 Sunscreen, you can safely walk outside to boost your vitamin D levels.” In various embodiments, the language model 139 can include hyperlink HTML markup, or custom tags denoting the beginning and ending of the insertion points, surrounding the product-capable substring 157 merged into the block of text. Subsequently, the language model 139 can return the rewritten content to the composer 403 and proceed to block 212. At block 212, the composer 403 (e.g. the rewriter service 145) can send the rewritten content to the orchestrator service 142. Subsequently, the process can continue to block 215 as previously described in the description of FIG. 2A.

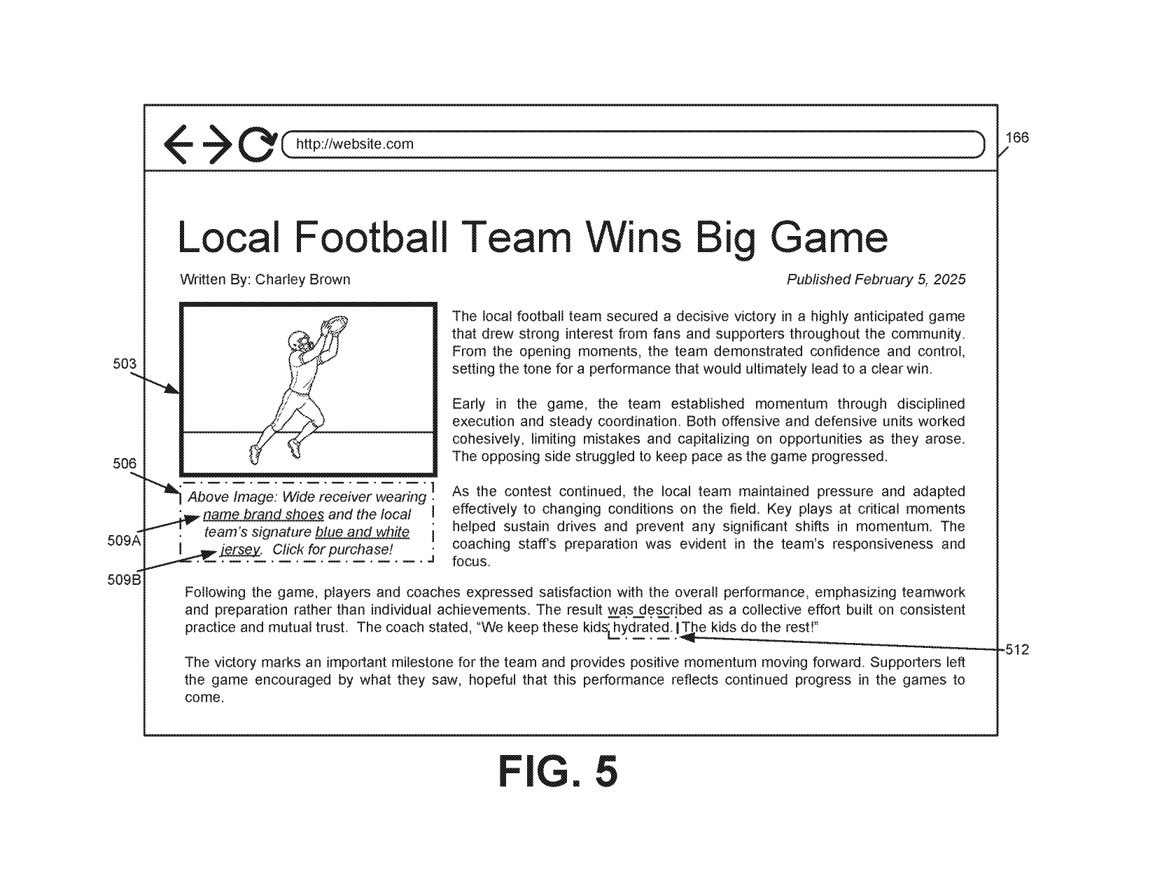

FIG. 5 depicts an example user interface rendered by a web browser 166 executing on a client device 106. In the illustrated embodiment, the web browser 166 displays a web page associated with an example uniform resource locator, such as “http://website.com,” that includes an article titled “Local Football Team Wins Big Game.” The web page includes textual content as well as an image 503 embedded within the article. As shown in FIG. 5, the image 503 depicts a football player catching a football. The image 503 can be processed by the captioner service 146 to generate caption content 506 that is displayed proximate to the image 503. The caption content 506 includes a textual description inferred from the image and surrounding content and includes product-capable substrings suitable for affiliate linking. In the illustrated example, the caption content 506 states “Above Image: Wide receiver wearing name brand shoes and the local team’s signature blue and white jersey. Click for purchase!” The caption content 506 includes a first affiliate link 509A corresponding to a product-capable substring “name brand shoes.” Selection of the affiliate link 509A navigates the user to an affiliate product 163 in the e-commerce environment 109 associated with footwear. The caption content 506 further includes a second affiliate link 509B corresponding to a product-capable substring “blue and white jersey.” Selection of the affiliate link 509B navigates the user to a different affiliate product 163 in the e-commerce environment 109 associated with team apparel.

FIG. 5 further illustrates that not all product-capable substrings present within the web page are required to be overwritten or hyperlinked. In the illustrated embodiment, additional product-capable substrings appear within the article text but are not modified to include affiliate links. This demonstrates that selective caption-based affiliate linking can be performed for image-derived content while other textual content remains unchanged, based on configuration settings, editorial controls, ranking thresholds, or other criteria described herein.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, by an orchestrator, content from a user device;
identifying a product-capable substring based on the content; and
obtaining, based on the product-capable substring, at least one product information structure that represents at least one product.

2. The method of claim 1, further comprising:
selecting a product information structure from the at least one product information structure, the product information structure representing a product;
inserting a link to purchase the product into the content; and
sending the content to the user device.

3. The method of claim 2, wherein inserting the link to purchase the product into the content includes at least one of:
appending the link to the content;
prepending the link to the content; or
rewriting the content to include the link along with additional content.

4. The method of claim 1, further comprising:
sending, by the orchestrator and in response to receiving the content from the user device, the content to a rewriter; and
receiving, by the orchestrator, the content from the rewriter such that the content is rewritten to include the product-capable substring.

5. The method of claim 1, wherein the at least one product information structure that represents the at least one product includes two or more product information structures representing two or more products, and the method further comprises ranking the two or more product information structures.

6. The method of claim 5, wherein ranking the two or more product information structures is based on one of a price history of the two or more products, a relevance of the two or more products to the product-capable substring, or similarity of keywords of the two or more products as compared to keywords related to the product-capable substring.

7. The method of claim 1, wherein identifying the product-capable substring further comprises:
sending, by the orchestrator, a prompt to a language model, the prompt directing the language model to identify product-capable substrings within the content and to identify each product-capable substring in the product-capable substrings as branded or generic; and
receiving, by the orchestrator and from the language model, the product-capable substring, wherein the product-capable substring is identified as at least one of a branded product or a generic product.

8. The method of claim 1, wherein the content comprises an image, and where the method further comprises generating, using a machine-learning model, a caption for the image to be included within the content.

9. An apparatus comprising:
one or more processors; and
a memory storing processor-executable instructions that, when executed by the one or more processors, cause the apparatus to:
receive, by an orchestrator, content from a user device;
identify a product-capable substring based on the content; and
obtain, based on the product-capable substring, at least one product information structure that represents at least one product.

10. The apparatus of claim 9, wherein the processor-executable instructions, when executed by the one or more processors, further cause the apparatus to:
select a product information structure from the at least one product information structure, the product information structure representing a product;
insert a link to purchase the product into the content; and
send the content to the user device.

11. The apparatus of claim 10, wherein the processor-executable instructions that insert the link to purchase the product into the content, when executed by the one or more processors, further cause the apparatus to at least:
append the link to the content;
prepend the link to the content; or
rewrite the content to include the link along with additional content.

12. The apparatus of claim 9, wherein the processor-executable instructions, when executed by the one or more processors, further cause the apparatus to:
send, by the orchestrator and in response to receiving the content from the user device, the content to a rewriter; and
receive, by the orchestrator, the content from the rewriter such that the content is rewritten to include the product-capable substring.

13. The apparatus of claim 9, wherein the at least one product information structure that represents the at least one product includes two or more product information structures representing two or more products, and wherein the processor-executable instructions, when executed by the one or more processors, further cause the apparatus to rank the two or more product information structures.

14. The apparatus of claim 9, wherein the processor-executable instructions that identify the product-capable substring, when executed by the one or more processors, further cause the apparatus to:
send, by the orchestrator, a prompt to a language model, the prompt directing the language model to identify product-capable substrings within the content and to identify each product-capable substring as branded or generic; and
receive, by the orchestrator and from the language model, the product-capable substring, wherein the product-capable substring is identified as at least one of a branded product or a generic product.

15. One or more non-transitory computer-readable media storing processor-executable instructions that, when executed by at least one processor, cause the at least one processor to:
receive, by an orchestrator, content from a user device;
identify a product-capable substring based on the content; and
obtain, based on the product-capable substring, at least one product information structure that represents at least one product.

16. The one or more non-transitory computer-readable media of claim 15, wherein the processor-executable instructions, when executed by the at least one processor, further cause the at least one processor to:
select a product information structure from the at least one product information structure, the product information structure representing a product;
insert a link to purchase the product into the content; and
send the content to the user device.

17. The one or more non-transitory computer-readable media of claim 16, wherein the processor-executable instructions that insert the link to purchase the product into the content, when executed by the at least one processor, further cause the at least one processor to at least:
append the link to the content;
prepend the link to the content; or
rewrite the content to include the link along with additional content.

18. The one or more non-transitory computer-readable media of claim 15, wherein the processor-executable instructions, when executed by the at least one processor, further cause the at least one processor to:
send, by the orchestrator and in response to receiving the content from the user device, the content to a rewriter; and
receive, by the orchestrator, the content from the rewriter such that the content is rewritten to include the product-capable substring.

19. The one or more non-transitory computer-readable media of claim 15, wherein the at least one product information structure that represents the at least one product includes two or more product information structures representing two or more products, and wherein the processor-executable instructions, when executed by the at least one processor, further cause the at least one processor to rank the two or more product information structures.

20. The one or more non-transitory computer-readable media of claim 15, wherein the processor-executable instructions that identify the product-capable substring, when executed by the at least one processor, further cause the at least one processor to:
send, by the orchestrator, a prompt to a language model, the prompt directing the language model to identify product-capable substrings within the content and to identify each product-capable substring as branded or generic; and
receive, by the orchestrator and from the language model, the product-capable substring, wherein the product-capable substring is identified as at least one of a branded product or a generic product.
